(19) United States
(12) Patent Application Publication
(10) Pub. No.: US 2013/0223661 A1
(43) Pub. Date: Aug. 29, 2013

(54) CUSTOMIZED HEARING ASSISTANCE DEVICE SYSTEM

(71) Applicant: Michael Uzuanis, Willowbrook, IL (US)

(72) Inventor: Michael Uzuanis, Willowbrook, IL (US)

(21) Appl. No.: 13/406,067

(22) Filed: Feb. 27, 2012

(51) Int. Cl. H04R 25/00

(52) U.S. Cl. 381/314

(57) ABSTRACT

A customized hearing assistance device system, or CHADS, including hearing profiles generated by a digital signal processor (DSP) device is also set forth. A microprocessor, configured to store the hearing profiles, each of the profiles including a plurality of audio parameters, is provided. The microprocessor can be operatively connected to an audio input and an audio output of the system. A modification interface is provided. The modification interface is operatively connected to the microprocessor. The modification interface is configured to selectively adjust any parameter of one of the hearing profiles, whereby a user of the CHADS can actuate the microprocessor to select one of the hearing profiles stored in the microprocessor. The user can employ the modification interface to adjust one or more parameters of the selected hearing profile in response to a change in the ambient sound environment.

### CROSS REFERENCE TO RELATED APPLICATIONS

NONE

### TECHNICAL FIELD

The concepts and embodiments herein relate generally to customizable hearing assistance device systems (CHADS).

### BACKGROUND

Significant improvements to auditory prosthesis devices, such as hearing devices and hearing aids, have been developed in recent years. Whereas early hearing devices, such as, for example, body-worn hearing devices, were once physically large and cumbersome, modern hearing aids provide device miniaturization and other improvements for the hearing impaired community. Hearing aids, which provide a small, comfortable and less bulky hearing improvement over other hearing devices, are worn in or on the ear. However, hearing aids are not advantageous for all populations.

For example, persons needing help with their daily care can encounter difficulties wearing and managing miniaturized hearing aids. The miniaturized hearing aids can be readily lost or misplaced, and the batteries may be difficult or impossible for some users to change. Further, for hearing aid users sharing a room, problems can arise with losing or confusing the devices in the room. Additionally, persons who share a room can be confined to their beds for long periods of time, and may be unable to freely choose a desired audio input at anytime, due to the needs or presence of a roommate.

Further, despite the attraction of hearing aid users to a less readily discernible miniaturized hearing aid device for appearance and other purposes, such devices still provide a visible sign of hearing disability of the user, as well as other disadvantages. Other disadvantages of the miniaturized hearing aid device can include, for example, a high cost to purchase, no enhancement of music by the processing, a stigma that the user is disabled due to the visibility of the device, limited compatibility for accessories, and mandatory reliance on an audiologist for device adjustments and programming.

Other known hearing device systems include body-worn hearing devices, often considered to be undesirable compared to miniaturized hearing aids, due to the bulk and available sound quality of such devices.

Additionally, known audiometers are limited to frequency ranges for speech, such as, for example the 250 to 8000 HZ range. In other words, frequency ranges tested via conventional audiometers omit hearing parameters other than speech frequencies.

### SUMMARY

Personal handheld devices, such as, for example, game devices and mobile phones, have become more common in recent years. For example, modern MP3 devices are now frequently worn by consumers of all ages. It is now fairly common to see persons wearing headphones or ear buds, and carrying a handheld portable MP3 player or other handheld device, for example.

As such, a hearing device system that blends into the sea of modern body worn and handheld devices would help some members of the hearing impaired community to forgo the typical outward physical appearance of a common hearing device or miniaturized hearing aid. Improving the listening experience for the user through such a device, as well as other advantages, would be a desirable improvement as well.

A customizable hearing assistance device system, or CHADS, including a digital signal processor (DSP) device connected to an audio input and an audio output, is set forth. A microprocessor is operatively connected to the DSP. The microprocessor is configured to store multiple hearing profiles, each hearing profile including a plurality of audio parameters. The hearing profiles can be generated, such as, for example, by the DSP and then stored in the microprocessor, or can be preset in the microprocessor. A modification interface is provided. The modification interface is operatively connected to the microprocessor. The modification interface is configured to selectively adjust any audio parameter of one of the multiple hearing profiles, whereby a user of the CHADS can selectively employ the modification interface to alter one or more of the audio parameters in response to a change in the ambient sound environment.

The stored hearing profile can be selectively adjusted as the device is moved between different sound environments by modifying the stored hearing profile in the microprocessor via the modification interface with, for example, a modification algorithm, or any other suitable mechanism. The modification algorithm can be stored, for example, in the microprocessor, or in any other suitable storage device. The modification algorithm can be operatively connected to the modification interface, without requiring a new hearing profile to accommodate the change in the ambient sound environment, as perceived by the CHADS user based on user input to the modification interface of the CHADS.

The hearing aid system can be miniaturized, if desired. The hearing aid system can be worn anywhere on the body, or carried. For example, the system can be fashioned as a handheld device, wherein, for example, pass-through ear buds can be provided to deliver a more natural sound to the user.

The system can thus provide customized sound delivery based on a number of stored hearing profiles, such that a listening experience closer to natural hearing can be achieved. Further, the system can be incorporated into a wearable device, if desired.

In an embodiment, the modification interface includes a touch screen, wherein a rapid adjustment of a stored hearing profile is selectively generated by altering the input to the touch screen.

The embodiment can be further defined by a modification interface that includes a wide-range frequency algorithm stored in the microprocessor, and operatively connected to the touch screen. An example of one suitable commercially available algorithm is, for example, EARS available from earmachine.com. Alternatively, any other suitable wide-frequency algorithm can be provided.

In an embodiment, a suitable sync program can be operatively connected to the microprocessor, and selectively operatively connected to associated sync devices, such as, for example, car stereos, televisions, stereos, and the like.

In an embodiment, the DSP device of the system can include a plurality of individual or dual DSP devices. The plurality of DSP device's can provide multiple audio outputs.

In an embodiment, the audio output includes an adapter for selectively connecting pass-thru ear buds to the system.

In yet another embodiment, the system includes receivers for receiving audio input. The receivers can be further defined by IR receivers. The receivers can also be further defined by Bluetooth receivers. The system can include both IR and Bluetooth receivers.

In an embodiment, the microprocessor of the system can be adapted to selectively store a hearing profile that is adjusted via the modification interface.

A customized hearing assistance device system, or CHADS, including hearing profiles generated by a digital signal processor (DSP) device is also set forth. A microprocessor, configured to store the hearing profiles, each of the profiles including a plurality of audio parameters, is provided. The microprocessor can be operatively connected to an audio input and an audio output of the system. A modification interface is provided. The modification interface is operatively connected to the microprocessor and to an exterior of the device. The modification interface is configured to selectively adjust any parameter of one of the hearing profiles, whereby a user of the CHADS can actuate the microprocessor to select one of the hearing profiles stored in the microprocessor. The user can employ the modification interface to adjust one or more parameters of the selected hearing profile in response to a change in the ambient sound environment.

A method of adjusting hearing profiles, generated by a DSP and stored in a customizable hearing assistance device system (CHADS), can include the following steps. First, input from a modification interface is employed to selectively adjust any parameter of the stored hearing profiles in response to a change in the ambient sound environment to produce a customized hearing profile. Next, the customized hearing profile can be stored in a microprocessor of the system.

In an embodiment, the methods and devices set forth herein can include hearing profiles generated via a DSP within a customized testing range for a customized CHADS listening device. The customized testing range can include frequencies ranging from, for example, 12 Hz to 20 kHz.

### DESCRIPTION OF THE DRAWINGS

FIG. 1 illustrates a schematic view of an exemplary embodiment of a customizable hearing assistance device system.

FIG. 1A illustrates a schematic view of an exemplary embodiment of a customizable hearing assistance device system including a touch screen.

FIG. 1B illustrates a schematic detailed view of an exemplary embodiment of a customizable hearing assistance device system including dual digital signal processors (DSP's).

FIG. 2 illustrates an exemplary method for providing a quick adjustment to a stored hearing profile in accordance with the principles herein.

FIG. 3 illustrates a perspective view of exemplary ear buds suitable for use in conjunction with the system of FIG. 1.

FIG. 4 illustrates an exploded view of a system incorporating Bluetooth and infrared (IR) receivers.

FIG. 5 illustrates graphically a conventional audiogram test.

### DETAILED DESCRIPTION

U.S. patent application Ser. No. 12/658,901 entitled “BODY-WORN HEARING AID SYSTEM”, filed Feb. 16, 2010, which is a continuation-in-part of U.S. patent application Ser. No. 12/270,385, entitled “PERSONAL LISTENING DEVICE WITH AUTOMATIC SOUND EQUALIZATION AND HEARING TEST”, filed Nov. 13, 2008 are both incorporated in the entirety herein by reference.

In accordance with the principles herein, an improved hearing assistance system that can both quickly modify stored hearing profiles and store modified hearing profiles is provided. The improved system can accommodate the need to quickly access and modify stored hearing profiles based on changes in the ambient sound environment, such as, for example, variable noise contributing factors in a room. Variable noise contributing factors can include, for example, the number of people in the room, whether windows are opened or closed, sound absorbency of furniture or draperies, construction noise, telephones ringing, and buzzing from electrical devices, to name a few.

The stored hearing profile can be quickly adjusted by a user. The system herein provides a quick adjustment of stored profiles based on changing conditions in the natural hearing environment of the user based on input by the user. In accordance with the principles herein, selectively and frequently adjusting a stored hearing profile to accommodate ever changing environmental factors produces sound quality for the customizable hearing assistance device system (CHADS) wearer that is closer to a non-impaired hearing experience. Further, the CHAD position and size can be selected to give the appearance of other common audio devices frequently used by non-hearing impaired individuals, such as, for example, an MP3 player. In addition, a suitable modification interface can be incorporated into the device, such as on an exterior of the device, to facilitate the quick adjustment, such as, for example, a touch screen.

In order to provide multiple hearing profiles for the system, either a set of hearing profiles determined by a DSP can be provided and stored in the system, or hearing profiles can be generated by an internal DSP and stored in the system, or both. Preferably, a base profile is first determined based on the results of an audiology exam, or a self-administered audiology test that determines a hearing profile as discussed, for example, in U.S. Patent application number 2010 0119093, of common inventive entity, to Uzuanis et al., filed Nov. 13, 2008. The base hearing profile can then be stored in memory associated with a suitable microprocessor, such as, for example, a digital signal processor (DSP) operatively connected to the improved hearing aid system, or any other suitable memory device.

Additional hearing profiles can be downloaded or preloaded into memory associated with the microprocessor, or generated in varied sound environments using, for example, a self-administered audiology test as discussed, for example, in U.S. Patent application number 2010 0119093. The additional hearing profiles are stored in memory operatively connected to or provided by the microprocessor. In accordance with the principles herein, any parameter of a selected, stored hearing profile can be selectively fine-tuned by the user to customize the sound of a particular hearing environment via a modification interface. In this manner, the modification interface can provide an adjustment to a selected stored hearing profile via, for example, any suitable modification algorithm. One such suitable modification algorithm is, for example, a commercially available product known as EARS from earmachine.com.

Audio parameters of stored hearing profiles include more than just volume characteristics as demonstrated, for example, in Graph A, shown below, of a conventional audiogram test. In accordance with the principles herein, the user can alter parameters including frequency and volume simultaneously to create a custom hearing experience.

In accordance with the principles herein, the procedure to store hearing profiles can be repeated to create a custom hearing profile for each ear of the user, if needed, or for one or more different users, and can be stored in memory associated with the microprocessor, or with a different microprocessor, if desired. To this end, the modification interface can include buttons or any other switch mechanism or algorithm provided in or on the device of the system, such as, for example a touch screen or any other suitable mechanism for selecting a name for the custom profile, such as, for example, Mike's left hearing profile, Mike's right hearing profile and/or Michele's left hearing profile, Michele's right hearing profile. Further, the user can modify the hearing profile via the modification interface of each ear individually, or of both ears simultaneously.

In an embodiment, the system can further include one or more receivers, such as, for example, Bluetooth or IR receivers, for receiving audio input. Where IR receivers are integrated into the system, electrical noise for the system must be minimized. Further, suitable audio filters must be selected.

Further, in another embodiment, the system can sync with other devices, so that custom hearing corrected sound can be streamed to the user via the audio device. The streamed sound can be provided directly to the user where ear buds are not needed, such as in car or home, thereby eliminating the need to upload and store a customized hearing profile in the other devices.

In accordance with the principles herein, a base hearing profile can be adjusted, for example, via a touchpad and associated application. One suitable touchpad application is, for example, EARS from earmachine.com. The base hearing profile can be adjusted to generate a modified profile that includes a consideration by the user of the actual noise in the environment in an expedited fashion. The modified hearing profile can then be stored, if desired. An output signal generated according to the modified hearing profile can be further processed to enhance the output signal via a suitable sound processing device or method.

In accordance with standards in the hearing aid industry, the headset used to take the hearing test must be calibrated to the processor. Tones generated by the test may not be accurate or true tones if the headset is not calibrated. Therefore, modifying stored hearing profile outputs without needing a calibrated test measurement to determine a hearing profile is an important feature of the principles herein, since a quick adjustment without calibrating needing to the headset allows the user to rapidly adjust the stored hearing profile to the natural environment.

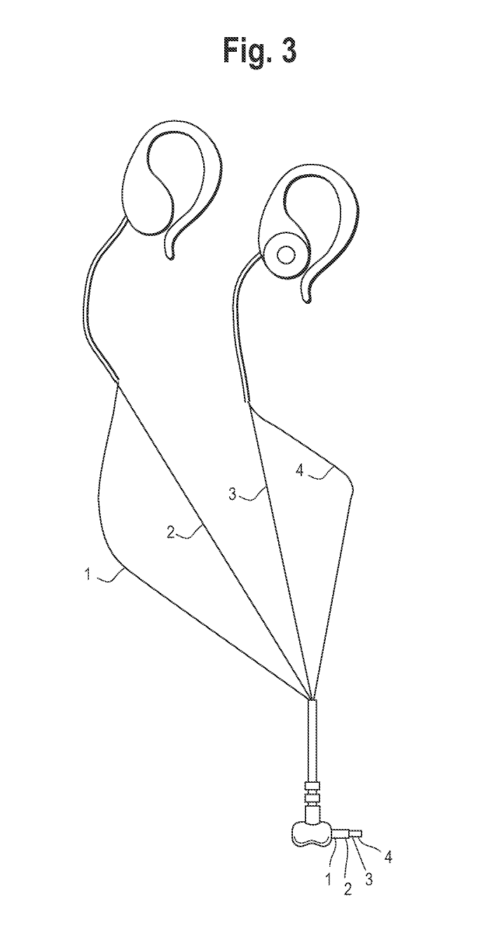

In accordance with the principles herein, ear buds providing a pass-thru listening experience, or other open fit hearing aid designs, provide an improved natural sound for the user to evaluate. One such suitable exemplary ear bud headset is shown generally at 300, for example, in FIG. 3, wherein vented earbuds available from Cotron provide optimum sound delivery without blocking ambient sound.

Alternatively, any suitable headset can be used to conduct the quick adjustment achieved in accordance with the principles herein.

Accommodating the ever changing sound environment of the hearing impaired in accordance with the principles herein results in a personal Soundprint™. The personal Soundprint™ allows the hearing impaired to quickly adjust stored profiles and/or fine tune their hearing profiles based on changes in their natural environment. Further, a device that blends more readily with devices used by non-impaired hearing individuals, while compensating for the ever changing sound environment to achieve a comfortable sound enhancement in the least amount of time, is achieved in accordance with the principles herein.

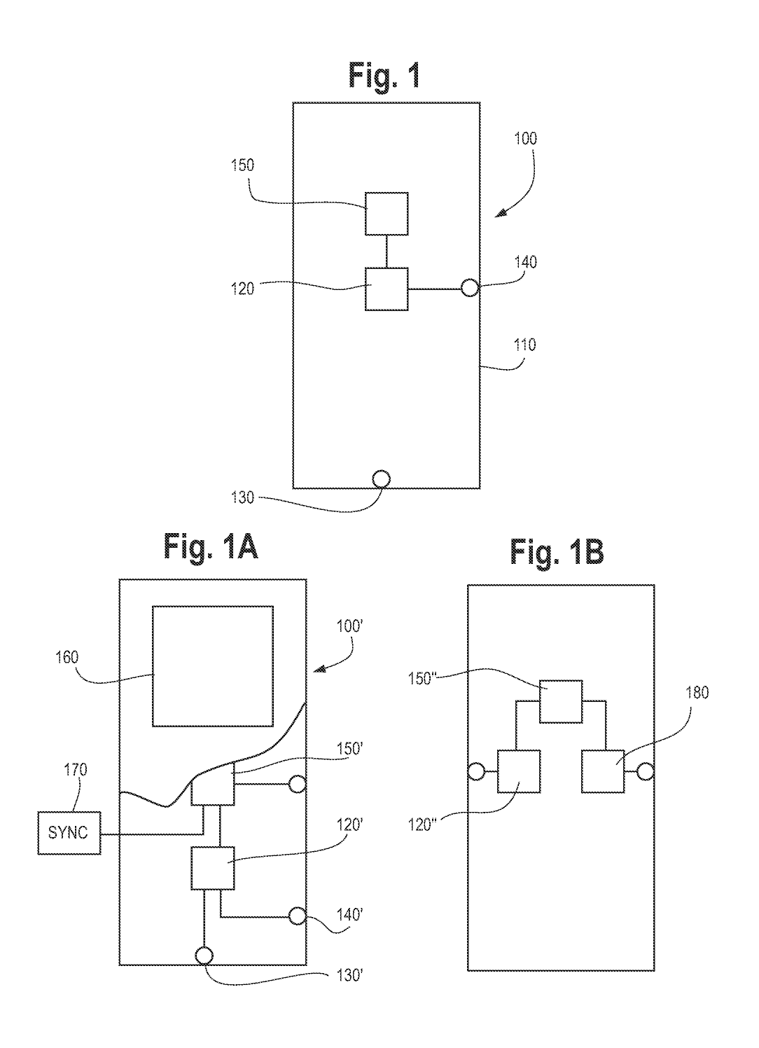

As illustrated in FIG. 1, an exemplary embodiment of a customizable hearing assistance device system (CHADS) shown generally at 100 can include a casing 110 incorporating, for example, a digital signal processor device (DSP) 120, if desired. The DSP 120 can be selectively and operatively connected to a suitable microprocessor, such as an internal microprocessor 150 or any other suitable microprocessor. An audio input 130 and an audio output 140 can be connected to either the DSP as shown, for example, or to the microprocessor 150, if desired.

As illustrated in FIG. 1A, a suitable modification interface, here including an exemplary touch screen, such as, for example, a touch screen 160 can be provided and connected to the system in any suitable manner, such as, for example, by connecting to the microprocessor 150′. A suitable sync program can be stored in the microprocessor 150′, or stored in a microprocessor 170 operatively connected to the system 100.

The DSP 120 of the system 100 can further include multiple DSP's, such as, for example DSP 120″ and DSP 180, as illustrated in FIG. 1B to achieve a binaural hearing system. Alternatively, a single DSP having split channel functionality can be provided in the system 100.

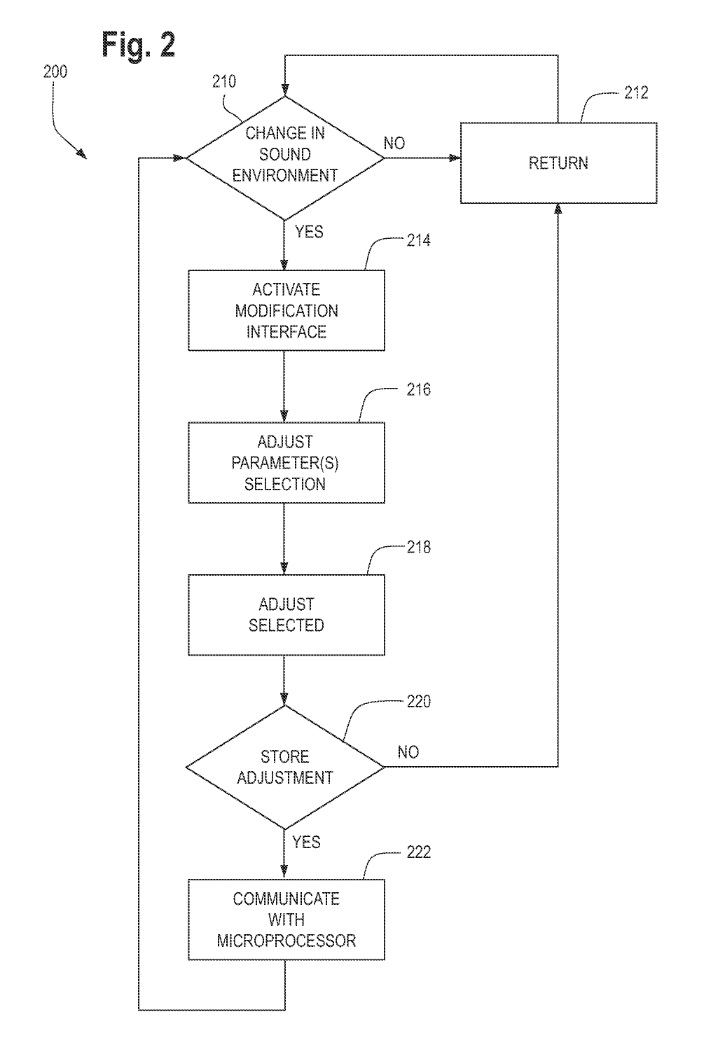

As illustrated in FIG. 2, the operation of the modification interface is shown generally at 200. The modification interface can incorporate, for example, an algorithm operatively stored in the microprocessor 150 of the system 100 of FIG. 1, or be otherwise operatively connected to the system 100 of FIG. 1 such as, for example, by a wireless connection.

In a first step 210, the modification algorithm prompts the user to indicate whether or not a threshold level change in the sound environment has occurred. For example, the threshold change can include an increase or decrease of noise in the sound environment. An alternative exemplary threshold change that can satisfy step 210 can include, for example, an increase or decrease in the range of 6 db in the sound environment.

If no threshold change has occurred at step 212, the algorithm can return to step 210. If a threshold change has occurred, the modification interface is actuated at step 214. Next, the user can select the parameter or parameter to be adjusted at step 216, and adjusts the parameters at step 218. If at step 220 the adjustment is not to be stored, the algorithm returns to step 212. If the adjusted profile is to be stored, the algorithm communicates with the microprocessor at 222 to store the adjusted profile, and the system then returns to step 210 to await further changes in the sound environment.

When a pass-through device, such as the earbuds shown generally at 300 in FIG. 3, is used in conjunction with the system herein the user can achieve an optimal natural sound environment that can be customized to accommodate both changes in the hearing environment and the user preferences, in accordance with the principles herein. In CHADS devices and systems incorporating receivers that can introduce noise into the system such as, for example, IR receivers, a separate ground can be provided. For example, ground lines 1 and 4 of FIG. 3, respectively, for the right and left ear input lines 2 and 3, respectively can be provided to reduce noise in the system.

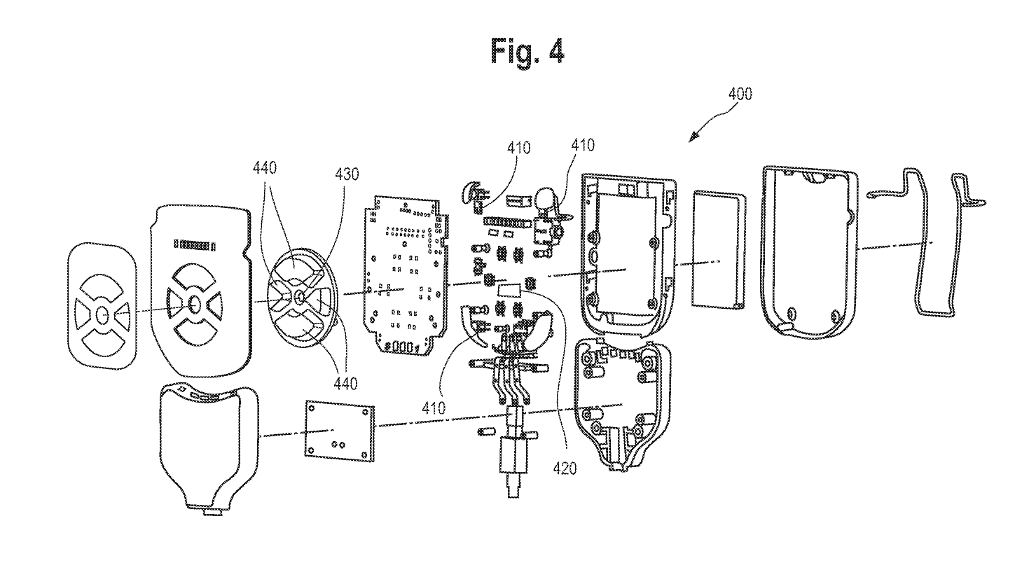

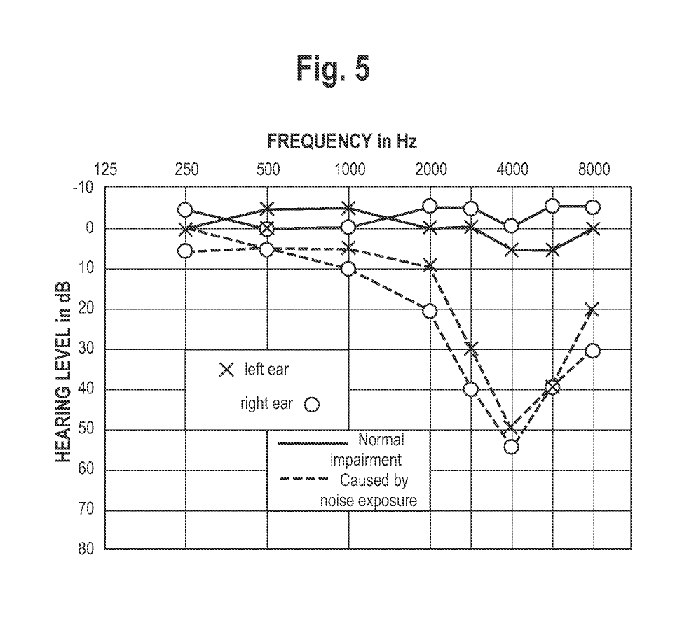

Further, integrated transmitters and receivers, such as IR and Bluetooth receiver, shown for example at 410 and 420, respectively in the device shown generally at 400 in FIG. 4 can assist in both syncing audio devices in the environment and in providing a custom sound delivery to the user, in accordance with the principles herein. A touch activated switch 430 and one or buttons 440 can serve as a modification interface for the CHADS of FIG. 4, or any other suitable modification interface, or combination of elements forming a suitable modification interface, can be employed.

Further, in accordance with the principles herein, a customized CHADS listening device including customized hearing profiles, includes hearing profiles generated by an audiometer employing a testing range of from about 12 Hz to 20 kHz. Advantageously, devices constructed in accordance with the principles herein provide benefits to all users seeking a customized listening experience, and is not limited to use by only hearing impaired users.

It is to be understood that embodiments of the present system and method may have a variety of different configurations and may be formed of a variety of materials. Depending on the application, there may be one or a plurality of structural elements. Also, the plurality of structural elements may be arranged in different configurations relative to one another depending on the application.

The present system and method are not limited to the particular details of the depicted embodiments and other modifications and applications are contemplated. Certain other changes may be made in the above-described embodiments without departing from the true spirit and scope of the present system and method herein involved. It is intended, therefore, that the subject matter of the above depiction shall be interpreted as illustrative and not in a limiting sense.

We claim:

1. A customizable hearing assistance device system (CHADS), comprising:
a digital signal processor (DSP) device operatively connected to an audio input and an audio output;
a microprocessor, configured to store multiple hearing profiles, each hearing profile including a plurality of audio parameters, the microprocessor being operatively connected to the DSP; and
a modification interface, operatively connected to the microprocessor, the modification interface configured to selectively adjust any audio parameter of one of the multiple hearing profiles, whereby the modification interface can be selectively manually employed to alter any audio parameter in response to a change in the ambient sound environment.

2. A customized hearing assistance device system as claimed in claim 1, wherein the modification interface includes a modification algorithm stored in the microprocessor.

3. A customized hearing assistance device system as claimed in claim 2, wherein the modification algorithm is responsive to manual input on a touch screen, wherein a rapid adjustment of the stored hearing profile is selectively generated by altering the input on the touch screen.

4. A customized hearing assistance device system as claimed in claim 3, wherein the modification algorithm is further defined by a wide range frequency algorithm stored in the microprocessor, and operatively connected to the touch screen.

5. A customized hearing assistance device system as claimed in claim 1, wherein a sync program is operatively connected to the microprocessor, and selectively operatively connected to associated sync devices.

6. A customized hearing assistance device system as claimed in claim 1, further comprising a second DSP stored in the system.

7. A customized hearing assistance device system as claimed in claim 1, wherein the DSP is further defined by a dual channel DSP.

8. A customized hearing assistance device system as claimed in claim 1, the audio output further comprising an adapter for selectively connecting pass-thru ear buds to the system.

9. A customized hearing assistance device system as claimed in claim 1, the system further comprising receivers for receiving audio input.

10. A customized hearing assistance device system as claimed in claim 9, the receivers further comprising IR receivers.

11. A customized hearing assistance device system as claimed in claim 9, wherein the receivers are further defined by Bluetooth receivers.

12. A customized hearing assistance device system as claimed in claim 11, wherein the modification interface is adapted and constructed to generate an automated adjustment to one of the stored hearing profiles.

13. A customized hearing assistance device system as claimed in claim 1, wherein the microprocessor is adapted and constructed to selectively store an adjusted hearing profile, wherein the adjusted hearing profile is adjusted via the modification interface.

14. A customized hearing assistance device system (CHADS) configured to store hearing profiles generated by an audiological test comprising:
a microprocessor configured to store the hearing profiles, each of the hearing profiles including a plurality of audio parameters;
an audio input and an audio output both operatively connected to the microprocessor;
a modification interface operatively connected to the microprocessor and to an exterior of the device, wherein the modification interface is configured to select one of the hearing profiles and to selectively adjust any parameter of the selected hearing profile;
wherein the modification interface is adapted and constructed to be responsive to changes in the ambient sound environment.

15. A customized hearing assistance device system (CHADS) as claimed in claim 14, wherein the modification interface includes a touch screen.

16. A customized hearing assistance device system (CHADS) as claimed in claim 14, wherein the modification interface includes a modification algorithm stored in the microprocessor.

17. A customized hearing assistance device system (CHADS) as claimed in claim 14, wherein a digital signal processor (DSP) is connected to the microprocessor in the system.

18. A method comprising the steps of:
a) providing manual input to a modification interface of a customizable hearing assistance device system (CHADS);
b) selectively adjusting any parameter of a stored hearing profile via the modification interface to produce an adjusted hearing profile;
c) selectively storing the custom hearing profile, if desired; and
e) selectively repeating steps a-c.

19. The method of claim 18, wherein the step of selectively adjusting any parameter of the stored hearing profile is further defined by providing a touch screen input to selectively adjust the stored hearing profile.

20. The method of claim 18, further comprising the step of delivering the adjusted hearing profile to an audio output of the CHADS.

21. A customized CHADS listening device including customized hearing profiles, the customized hearing profiles including hearing profiles generated by an audiometer employing a testing range of from about 12 Hz to 20 kHz.
